(19) United States
(12) Patent Application Publication
(10) Pub. No.: US 2022/0304539 A1
(43) Pub. Date: Sep. 29, 2022

(54) CLEANING BASE STATION

(71) Applicant: SHENZHEN FLY RODENT DYNAMICS INTELLIGENT TECHNOLOGY CO.,LTD., Shenzhen (CN)

(72) Inventor: Lianrong ZHENG, Shenzhen (CN)

(21) Appl. No.: 17/555,859

(22) Filed: Dec. 20, 2021

(30) Foreign Application Priority Data
Mar. 23, 2021 (CN) 202110307913.8

(51) Int. Cl. A47L 11/40; B08B 3/02; A47L 11/28

(52) U.S. Cl. CPC A47L 11/4091; B08B 3/02; A47L 11/28; A47L 2201/028

(57) ABSTRACT

The present application provides a cleaning base station, including a base, a cleaning tank for cleaning wipers, and a first sewage tank for storing sewage. The cleaning tank is arranged in the base, an entrance is arranged on the base for a cleaning robot to enter the cleaning tank, a side of the base is defined with an opening configured for allowing the cleaning tank to be taken out, and the first sewage tank is connected to the cleaning tank. In the cleaning base station, by connecting the first sewage tank to the cleaning tank, and defining an opening on the side of the base, when cleaning the first sewage tank and the cleaning tank and taking out the cleaning tank from the base, the first sewage tank is disassembled to take out the cleaning tank and the first sewage tank at one time.

### CROSS-REFERENCE TO RELATED APPLICATIONS

The present application claims the priority of the Chinese patent application with application NO. 202110307913.8 filed at the China National Intellectual Property Administration on Mar. 23, 2021, the entire content of which is incorporated into the present application by reference.

### TECHNICAL FIELD

The present application relates to the technical field of cleaning equipment, and more particularly relates to a cleaning base station.

### BACKGROUND

At present, for the cleaning wiper on the cleaning robot, the cleaning robot is generally arranged at the side of the pool for manual cleaning. Particularly when mopping the floor, some users often clean the mopping piece multiple times, which is inconvenient to clean and water is easy to splash during cleaning. In view of this, a cleaning base station is proposed in the related art, that is, a base station with a cleaning function. A cleaning mechanism is arranged in the base station of the cleaning robot to clean the wiper of the cleaning robot. In related technologies, it is generally to arrange a cleaning tank and a sewage tank in the base, and arrange an entrance at the bottom of the base, so that sanitary ware can be arranged in the cleaning tank from the entrance for cleaning, and the generated sewage is collected in the sewage tank for convenient cleaning and thereby saving water. After the cleaning base station has been used for a period of time, it is generally necessary to clean the cleaning tank and discharge the sewage in the sewage tank. Currently, an opening is generally arranged on the top of the base to remove the sewage tank, and the cleaning tank is removed from the entrance on the base to clean the cleaning tank. However, with this structure, it is necessary to take out the cleaning tank and the sewage tank from the base separately, which is inconvenient to clean.

### SUMMARY

The purpose of the embodiments of the present application is to provide a cleaning base station to solve the problem that the cleaning tank and the second sewage tank need to be dismantled separately and the cleaning is inconvenient.

In order to achieve the above objective, the technical solution adopted in the embodiments of the present application is to provide a cleaning base station, including a base, a cleaning tank for cleaning wipers, and a first sewage tank for storing sewage.

The cleaning tank is arranged in the base, an entrance is arranged on the base for a cleaning robot to enter the cleaning tank, a side of the base is defined with an opening configured for allowing the cleaning tank to be taken out, and the first sewage tank is connected to the cleaning tank.

In an optional embodiment, the cleaning tank is detachably connected to the first sewage tank.

In an optional embodiment, the first sewage tank is arranged beneath the cleaning tank.

In an optional embodiment, a bottom of the cleaning tank is provided with an accommodation cavity, and the first sewage tank is arranged in the accommodation cavity.

In an optional embodiment, a side of the accommodating cavity away from the entrance or/and a side of the accommodating cavity close to the entrance are open, and the first sewage tank is inserted into the accommodating cavity.

In an optional embodiment, a bottom of the accommodating cavity is open, and a side wall of the accommodating cavity is arranged around the first sewage tank.

In an optional embodiment, the cleaning base station further includes an integrated box with an open top, wherein a supporting plate for supporting the cleaning robot is arranged in the integrated box, a part of the integrated box beneath the supporting plate constitutes the first sewage tank, and a part of the integrated box above the supporting plate constitutes the cleaning tank.

In an optional embodiment, a width of the supporting plate is smaller than a width of the integrated box; or the integrated box is separated by the supporting plate, and the supporting plate defines a through hole.

In an optional embodiment, the first sewage tank at least partially extends out of the base.

In an optional embodiment, a part of the first sewage tank extending from the base extends to the opposite sides of the base and a side of the base away from the entrance.

In an optional embodiment, the first sewage tank is arranged in a U-shape, the first sewage tank is enclosed into a U-shaped groove, and the cleaning tank is arranged in the U-shaped groove.

In an optional embodiment, the cleaning base station further includes a water purification tank, wherein the water purification tank is U-shaped, and the water purification tank is enclosed into a U-shaped cavity; and the first sewage tank is arranged in the U-shaped cavity, and the cleaning tank is arranged in the U-shaped groove; or, the water purification tank is arranged in the U-shaped groove, and the cleaning tank is arranged in the U-shaped cavity.

In an optional embodiment, the cleaning base station further includes a second sewage tank, wherein the second sewage tank is arranged on the outside of the base, and the second sewage tank is connected to the cleaning tank.

In an optional embodiment, the opening is defined on a side of the base away from the entrance or/and a side of the base close to the entrance.

In an optional embodiment, the cleaning tank is inclined downward on a side close to the entrance.

Advantages of the cleaning base station provided by embodiments of the application are summarized as follows:

compared with the existing technology, in the cleaning base station of the application, the first sewage tank is connected to the cleaning tank, an opening is defined on the side of the base to clean the first sewage tank. When cleaning the first sewage tank and cleaning tank, when removing the cleaning tank from the base, the first sewage tank can be removed from the base at the same time, so that the cleaning tank and the first sewage tank can be taken out at one time, which is convenient for the cleaning treatment of the cleaning tank and the first sewage tank. When assembling, the cleaning tank and the first sewage tank can be assembled on the base together, which is easy to use.

### BRIEF DESCRIPTION OF THE DRAWINGS

In order to more clearly describe the technical solutions in the embodiments of the present application, the following will briefly introduce the accompanying drawings used in the description of the embodiments or exemplary technologies. Obviously, the accompanying drawings in the following description are only some embodiments of the present application. Those of ordinary skill in the art can obtain other drawings based on these drawings without creative work.

FIG. 1 is a schematic diagram of a cleaning base station structure when cleaning a cleaning robot provided by an embodiment of the present application;

FIG. 2 is a schematic diagram of a side view structure of a cleaning base station provided by an embodiment of the present application;

FIG. 3 is a schematic side view of the base structure in FIG. 2;

FIG. 4 is a schematic side view of the cleaning tank and first sewage tank of the cleaning base station in FIG. 2;

FIG. 5 is a schematic diagram of a side view structure of a cleaning base station provided by another embodiment of the present application;

FIG. 6 is a schematic side view of the cleaning tank and first sewage tank of the cleaning base station in FIG. 5;

FIG. 7 is a schematic side view of the cleaning base station when cleaning the cleaning robot provided by another embodiment of the present application;

FIG. 8 is a schematic diagram of the structure of an integrated groove provided by an embodiment of the present application;

FIG. 9 is a schematic diagram of the structure of an integrated groove provided by another embodiment of the present application;

FIG. 10 is a schematic side view of a cleaning tank and a first sewage tank provided by another embodiment of the application;

FIG. 11 is a schematic side view of THE structure of a cleaning base station provided by another embodiment of the present application;

FIG. 12 is a schematic side view OF THE structure of a cleaning base station provided by another embodiment of the present application;

FIG. 13 is a schematic top view of a cleaning tank and a first sewage tank provided by another embodiment of the application;

FIG. 14 is a schematic top view of a cleaning tank, a first sewage tank, and a water purification tank provided by another embodiment of the application

The main reference numbers of the drawings are as following:
100—cleaning base station;
10—base; 11—entrance; 12—opening;
20—integrated box; 201—supporting plate; 202—through hole; 21—cleaning tank; 211—accommodation cavity; 22—first sewage tank; 220—U—shaped groove; 23—second sewage tank; 24—water purification tank; 240—U—shaped cavity;

90—cleaning robot; 91—wiper.

### DETAILED DESCRIPTION

In order to make the technical problems to be solved by the present application, technical solutions, and beneficial effects clearer, the following further describes the present application in detail with reference to the accompanying drawings and embodiments. It should be understood that the specific embodiments described here are only used to explain the present application, and are not used to limit the present application.

It should be noted that when an element is referred to as being “fixed to” or “disposed on” another element, it can be directly on the other element or indirectly on the other element. When an element is said to be “connected to” another element, it can be directly connected to the other element or indirectly connected to the other element.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include one or more of these features. In the description of the present application, “a plurality of ” means two or more than two, unless otherwise specifically defined. The meaning of “several” is one or more than one, unless otherwise specifically defined.

In the description of the present application, it should be understood that the orientation or positional relationship indicated by the terms of “center”, “length”, “width”, “upper”, “lower”, “front”, “rear”, “left”, “right”, “vertical”, “horizontal”, “top”, “bottom”, “inner”, “outer” etc. is based on the orientation or positional relationship shown in the drawings, and is only for the convenience of describing the application and simplifying the description, rather than indicating or implying that the pointed device or element must have a specific orientation, be constructed and operated in a specific orientation, and therefore cannot be understood as a limitation of the present application.

Reference to “one embodiment”, “some embodiments” or “embodiments” described in the specification of the present application means that one or more embodiments of the present application include a specific feature, structure, or characteristic described in combination with the embodiment. Therefore, the phrases of “in one embodiment”, “in some embodiments”, “in some other embodiments”, “in some other embodiments”, etc. appearing in different places in this specification are not necessarily all refer to the same embodiment, but mean “one or more but not all embodiments” unless otherwise specifically emphasized in other ways. In addition, in one or more embodiments, specific features, structures, or characteristics may be combined in any suitable manner.

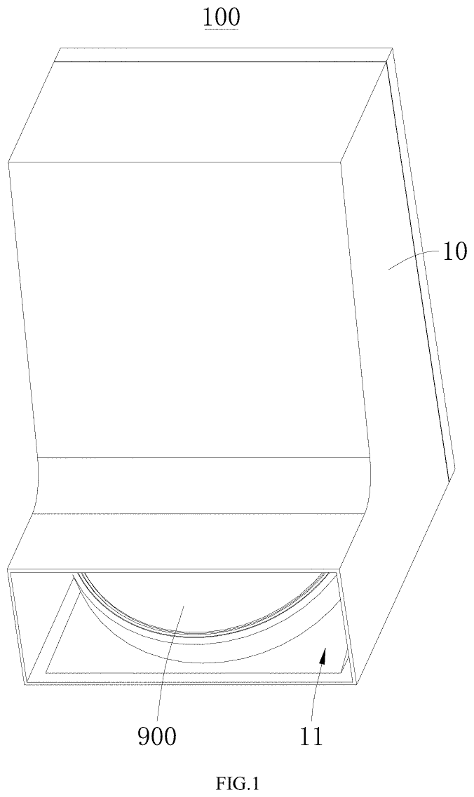

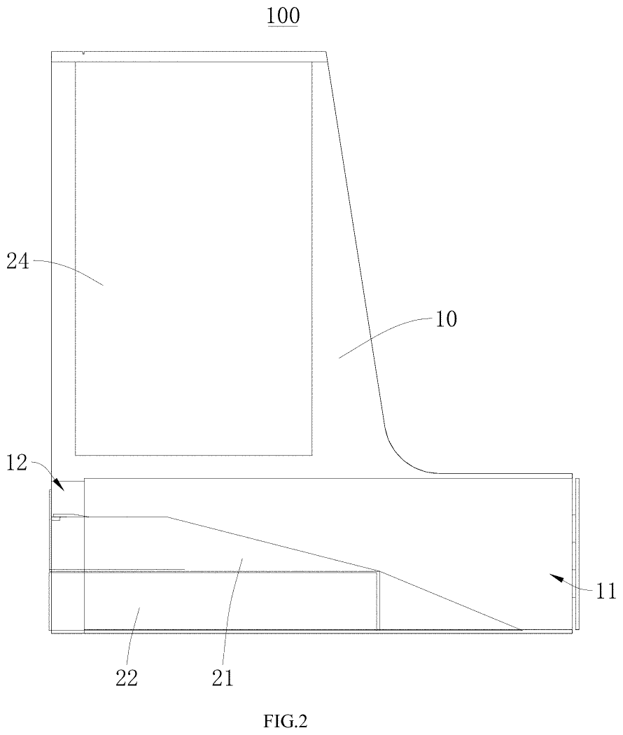

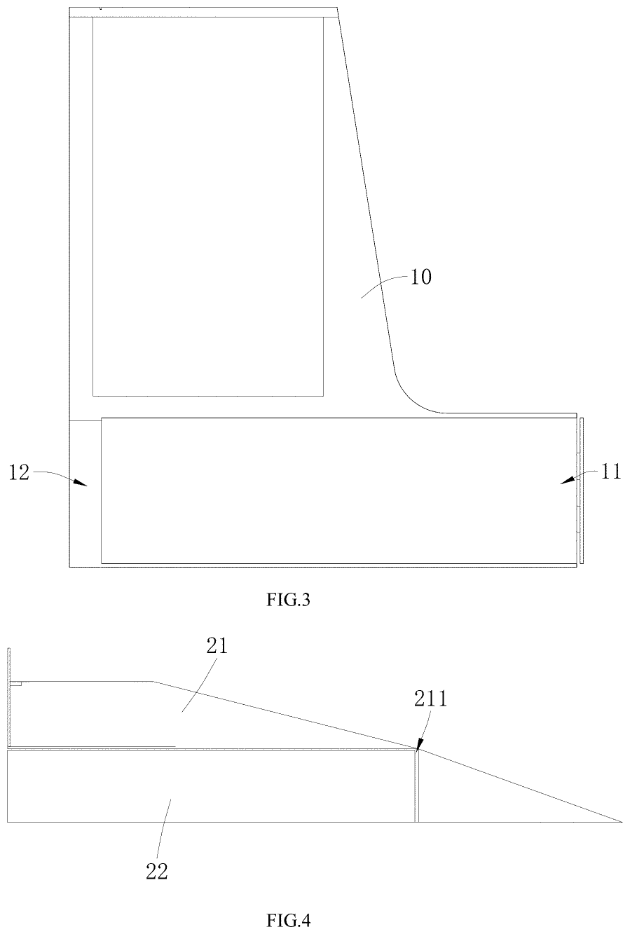

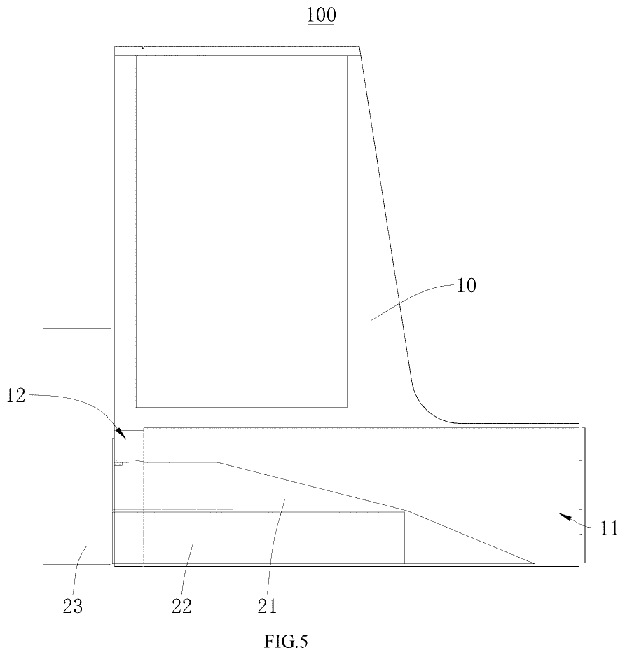

Referring to FIGS. 1 -4, FIG. 1 shows a schematic diagram of the three-dimensional structure of the cleaning base station 100 of this embodiment, and also shows the state of the cleaning robot 90 when cleaning on the cleaning tank 21 in the base 10. FIG. 2 is a schematic side view of the structure of the cleaning base station 100 provided by this embodiment, and shows the internal structure of the base 10. FIG. 3 is a schematic side view of the structure of base 10 in this embodiment. FIG. 4 is a schematic side view of the structure of the cleaning tank 21 and the first sewage tank 22 of this embodiment.

Referring to FIG. 1 and FIG. 2, the cleaning base station 100 includes a base 10, a cleaning tank 21 and a first sewage tank 22. The cleaning tank 21 is configured for cleaning the wiper, that is, the wiper is arranged in the cleaning tank 21 to perform the cleaning of the wiper. The first sewage tank 22 is used to store sewage, that is, the sewage after cleaning the wiper in the cleaning tank 21 is discharged to the first sewage tank 22 for storage. The cleaning tank 21 is arranged in the base 10, and the base 10 has an entrance 11. The cleaning robot 90 can enter the base 10 from the entrance 11 and enter the cleaning tank 21 to clean the wiper of the cleaning robot 90 in the cleaning tank 21 to facilitate cleaning and prevent water splashing.

Referring to FIGS. 2-4, the side of base 10 is provided with an opening 12, the opening 12 is configured for allowing the cleaning tank 21 to be taken out, that is, the cleaning tank 21 can be removed the base 10 from the opening 12 in order to clean the cleaning tank 21. The first sewage tank 22 is connected to the cleaning tank 21, so that when the cleaning tank 21 is taken out, the first sewage tank 22 can be taken out together, which is convenient for cleaning the cleaning tank 21 and the first sewage tank 22. There is no need to take out the first sewage tank 22 and the cleaning tank 21 in stages, which is convenient to use.

Compared with the existing technology, in the cleaning base station 100 provided by the present application, the first sewage tank 22 is connected to the cleaning tank 21 and an opening 12 is defined on the side of the base 10. When cleaning the first sewage tank 22 and the cleaning tank 21, and removing the cleaning tank 21 from the base 10, the first sewage tank 22 is removed from the base 10 together, so that the cleaning tank 21 and the first sewage tank 22 can be taken out at one time, which is convenient for the cleaning treatment of the cleaning tank 21 and the first sewage tank 22.When assembly, the cleaning tank 21 and the first sewage tank 22 are assembled on base 10 together, which is easy to use.

In one embodiment, the cleaning base station 100 can clean the wiper 91 for the cleaning robot 90, and optionally has maintenance functions such as charging or/and replacing the mop or/and drying the mop. The cleaning method of the member 91 includes, but is not limited to, a single clean water rinse, a combined clean water rinse and mechanical friction cleaning, or an ultrasonic cleaning method. The wiper 91 can be a flat wiper, such as a square or an irregular flat wiper; the wiper 91 can also be a roller wiper, such as a sponge roller brush, or other rollers wrapped with mopping materials such as cloth strips, the wiper 91 may also be a mopping member of other shapes for mopping the surface to be cleaned.

In an embodiment, referring to FIGS. 2 and 3, the opening 12 is defined on the side of base 10 facing away from entrance 11, so that the cleaning tank 21 and the first sewage tank 22 can be taken out from the side of base 10 facing away from entrance 11. In another embodiment, the opening 12 may be provided on the side of the base 10 close to the entrance 11 to take out the cleaning tank 21 and the first sewage tank 22 from the side of the base 10 close to the entrance 11. It is understandable, in some other embodiments, the opening 12 may be defined on the side of base 10 facing away from entrance 11 and the side of base 10 close to entrance 11 at the same time, so as to facilitate the disassembly and assembly of cleaning tank 21 and first sewage tank 22.

In one embodiment, the cleaning base station 100 further includes a water purification tank 24, and the water purification tank 24 is provided to provide purified water to the cleaning tank 21 when cleaning is required to facilitate cleaning. It is understandable, in some other embodiments, the cleaning tank 21 can be directly supplied with purified water through a faucet, without the water purification tank 24 being provided.

In one embodiment, referring to FIG. 4, the first sewage tank 22 is arranged beneath the cleaning tank 21, so that when the wiper is cleaned in the cleaning tank 21, the generated sewage can flow directly into the first sewage tank 22, thereby eliminating the need for pumps for taking out the sewage to facilitate use and reduce costs.

In one embodiment, an accommodation cavity 211 may be arranged at the bottom of the cleaning tank 21, and the first sewage tank 22 may be arranged in the accommodation cavity 211, so that the first sewage tank 22 is arranged beneath the cleaning tank 21, and the installation and position layout of the first sewage tank 22 can be facilitated.

In one embodiment, the first sewage tank 22 and the cleaning tank 21 can be detachably connected, so that after the cleaning tank 21 and the first sewage tank 22 are taken out and separated for separate cleaning. It is understandable, in other embodiments, the first sewage tank 22 and the cleaning tank 21 can be fixedly connected, and is taken out and cleaned together during cleaning.

In one embodiment, the first sewage tank 22 can be connected to the cleaning tank 21 in a buckle connection, for example, a buckle is arranged in the accommodation cavity 211, and a hook is arranged on the first sewage tank 22 to connect the first sewage tank 22 to the cleaning tank 21 in a buckle connection. Therefore, the first sewage tank 22 and the cleaning tank 21 can be disassembled and assembled together, and after the first sewage tank 22 and the cleaning tank 21 are taken out, they are disassembled and cleaned.

It is understandable, in other embodiments, a sliding rail can be arranged in the accommodation cavity 211, and a chute can be arranged on the first sewage tank 22 to slide the first sewage tank 22 into the accommodation cavity 211 to realize the sliding connection between the first sewage tank 22 and the cleaning tank 21. It is also possible to disassemble the first sewage tank 22 and the cleaning tank 21 together, and after taking out the first sewage tank 22 and the cleaning tank 21,the first sewage tank 22 and the cleaning tank 21 can be disassembled and cleaned.

In some other embodiments, a chute can be arranged in the accommodation cavity 211, and a roller can be arranged on the first sewage tank 22 to roll the first sewage tank 22 into the accommodation cavity 211 to realize the rolling connection between the first sewage tank 22 and the cleaning tank 21. The first sewage tank 22 and the cleaning tank 21 can be disassembled together, and after the first sewage tank 22 and the cleaning tank 21 are taken out, the first sewage tank 22 and the cleaning tank 21 can be disassembled and cleaned.

In one embodiment, the side of accommodation cavity 211 facing away from entrance 11 is arranged to be open, and the first sewage tank 22 is inserted into accommodation cavity 211. This structure can facilitate the disassembly and assembly of first sewage tank 22 from the side of cleaning tank 21 facing away from entrance 11. When taking out the cleaning tank 21, the first sewage tank22 is easily brought out. It is understandable, in other embodiments, a side of accommodation cavity 211 close to entrance 11 is arranged to be open, so that the first sewage tank 22 can be easily disassembled from the side of cleaning tank 21 close to entrance 11, and the first sewage tank 22 can be easily taken out when the cleaning tank 21 is taken out. In some other embodiments, a side of the accommodation cavity 211 facing away from the entrance 11 is arranged to be open at the same time, and a side of the accommodation cavity 211 side close to the entrance 11 is arranged to be open.

In some other embodiments, the bottom of the accommodation cavity 211 can be open, and the side walls of the accommodation cavity 211 are arranged around the first sewage tank 22, that is, the bottom of the cleaning tank 21 is covered on the first sewage tank 22. This structure can better assemble the first sewage tank 22 and the cleaning tank 21 by position.

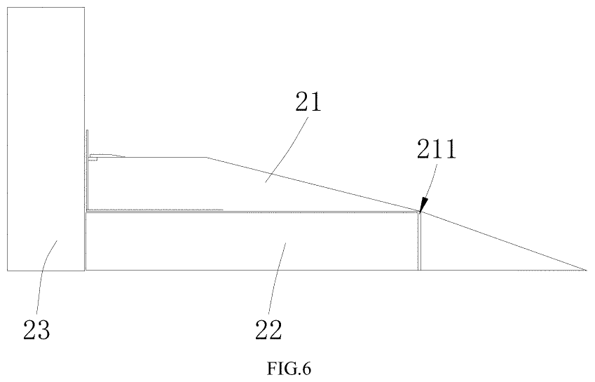

Referring to FIG. 5 and FIG. 6, FIG. 5 is a schematic side view of the structure of the cleaning base station 100 provided in this embodiment, and shows the internal structure of the base 10. FIG. 6 is a schematic side view of the structure of the cleaning tank 21 and the first sewage tank 22 of this embodiment. The structure of this embodiment is a modification on the basis of FIG. 2. In this embodiment, the cleaning base station 100 also includes a second sewage tank 23, the second sewage tank 23 is arranged on the outer side of the base 10, and the second sewage tank 23 is connected to the cleaning tank 21. The arrangement of the second sewage tank 23 can store more sewage and reduce the cleaning times of the cleaning base station100, which is convenient for use. In addition, the second sewage tank 23 is connected to the cleaning tank 21. When the second sewage tank 23 is taken out, the cleaning tank 21 and the first sewage tank 22 can be taken out together to facilitate cleaning.

In one embodiment, the second sewage tank 23 can be detachably connected to the cleaning tank 21. After the second sewage tank 23 and the cleaning tank 21 are separated from the base 10, the second sewage tank 23 and the cleaning tank 21 can be disassembled for separate cleaning and convenient cleaning. It is understandable, in some embodiments, the second sewage tank 23 can be fixedly connected to the cleaning tank 21 for disassembly and cleaning together.

In one embodiment, the second sewage tank 23 and the first sewage tank 22 may be fixedly connected for cleaning together. It is understandable, in other embodiments, the second sewage tank 23 and the first sewage tank 22 can be detachably connected, so that the second sewage tank 23 and the first sewage tank 22 can be cleaned separately.

In one embodiment, when the second sewage tank 23 is arranged, the sewage in the first sewage tank 22 can be discharged to the second sewage tank 23 through a pump, so that the first sewage tank 22 can dump the sewage. It is understandable, in some embodiments, when the height of the second sewage tank 23 is lower than the height of the cleaning tank 21, the sewage generated by the cleaning tank 21 can be discharged to the second sewage tank 23, which eliminates the need for pumps to reduce costs.

In one embodiment, the second sewage tank 23 can be connected to the cleaning tank 21 to realize the detachable connection between the second sewage tank 23 and the cleaning tank 21. It is understandable, a sliding rail can also be arranged on the cleaning tank 21, and a chute is arranged on the second sewage tank 23, and the chute is matched with the sliding rail to realize the sliding connection between the second sewage tank 23 and the cleaning tank 21.

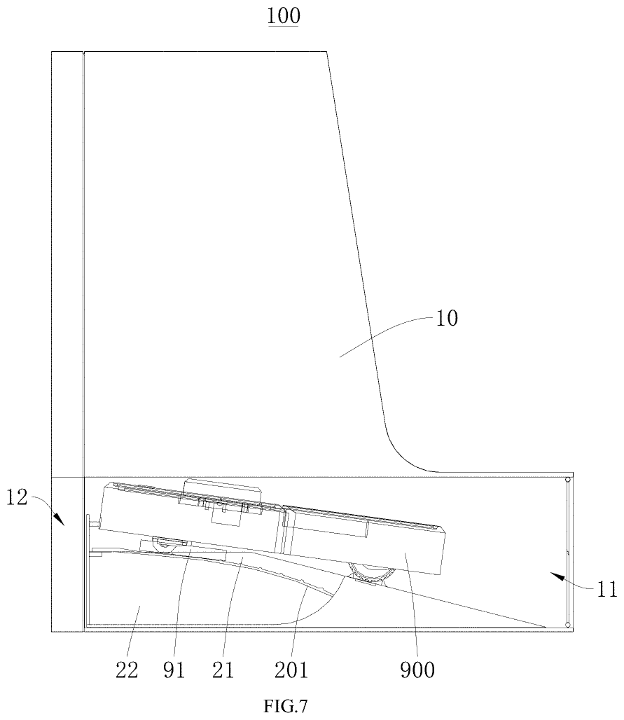

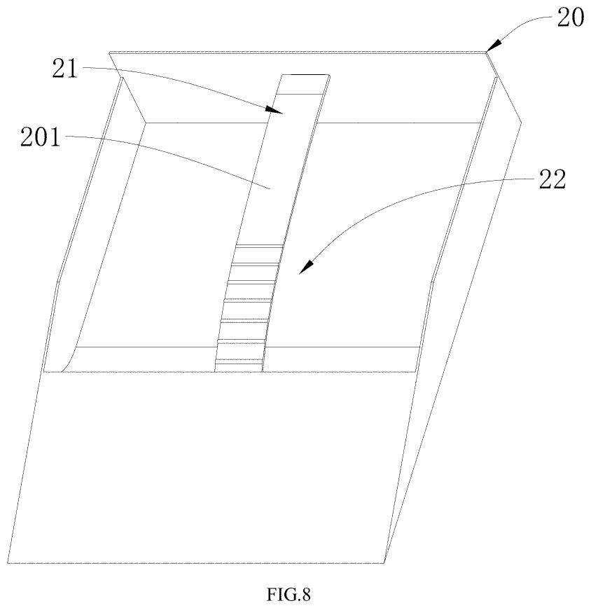

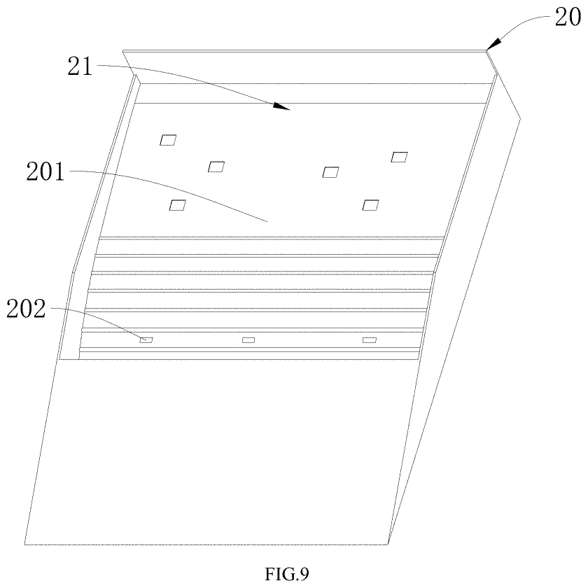

Referring to FIGS. 7 and 8, FIG. 7 is a schematic side view of the cleaning base station 100 provided by this embodiment, and shows the internal structure of the base 10, and also shows that the cleaning robot 90 is cleaning on the cleaning tank 21 in the base 10 status. FIG. 8 is a schematic perspective view of the cleaning tank 21 and the first sewage tank 22 of this embodiment. The structure of this embodiment is a modification on the basis of FIG. 2.

In one embodiment, referring to FIGS. 7 and 8, the cleaning base station 100 includes an integrated box 20, the top of the integrated box 20 is open, and the integrated box 20 is provided with a supporting plate 201, and the supporting plate 201 is used to support the cleaning robot 90 for cleaning the wiper 91 of the cleaning robot on the integrated box 20. Therefore, the part of the integrated box 20 above the supporting plate 201 constitutes the cleaning tank 21, and the part of the integrated box 20 beneath the supporting plate 201 constitutes the first sewage tank 22. This structure can realize the integration of the cleaning tank 21 and the first sewage tank 22, which is convenient for processing, manufacturing, and disassembly.

In one embodiment, the width of the supporting plate 201 is smaller than the width of the integrated box 20. This structure makes the side of the supporting plate 201 of the integrated box 20 form a communication port, so that the cleaning tank 21 is connected to the first sewage tank 22 so that the generated sewage can flow directly to the first sewage tank22.

In one embodiment, the two ends of the supporting plate 201 are connected to the side of the integrated box 20 close to the entrance 11 and the side away from the entrance 11, respectively, so that the supporting plate 201 is installed in the integrated box 20 to ensure the stability of the connection. It is understandable, in other embodiments, the supporting plate 201 may also be fixed in the integrated box 20 by a bracket.

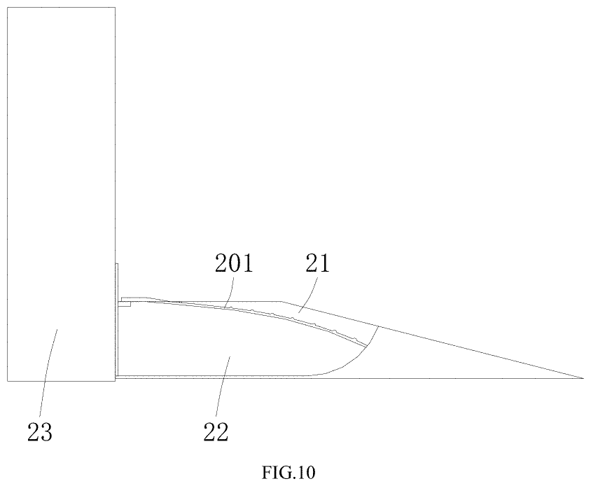

Referring to FIG. 9, FIG. 9 is a schematic perspective diagram of the cleaning tank 21 and the first sewage tank 22 of this embodiment. The structure of this embodiment is a modification on the basis of FIG. 8. In this embodiment, the supporting plate 201 separates the integrated box 20, and the supporting plate 201 is defined with a through hole 202, that is, two sides of the supporting plate 201 are connected to opposite sides of the integrated box 20 to separate the cleaning tank 21 and the first sewage tank 22. The through hole 202 is defined on the supporting plate 201, so that the sewage in the cleaning tank 21 can flow to the first sewage tank 22.

In one embodiment, the side of the cleaning tank 21 close to the entrance 11 is inclined downward, so that the sewage in the cleaning tank 21 can be concentrated to be discharged into the first sewage tank 22.

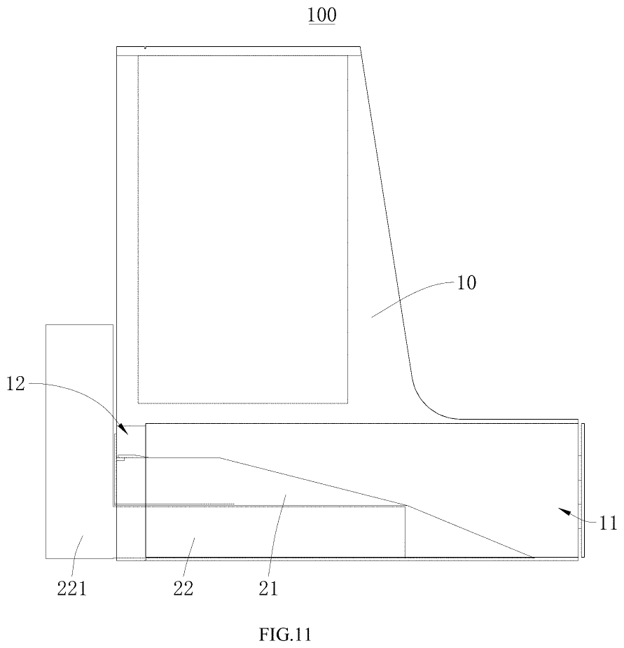

Referring to FIG. 10, which is a schematic perspective view of the cleaning tank 21, the first sewage tank 22 and the second sewage tank 23 of this embodiment. The structure of this embodiment is a modification on the basis of FIG. 8. In this embodiment, the cleaning base station 100 also includes a second sewage tank 23, and the second sewage tank 23 is connected to the cleaning tank 21. The arrangement of the second sewage tank 23 can store more sewage and reduce the cleaning times of the cleaning base station100, which is convenient for use. In addition, the second sewage tank 23 is connected with the cleaning tank 21. When the second sewage tank 23 is taken out, the cleaning tank 21 and the first sewage tank 22 can be taken out together to facilitate cleaning.

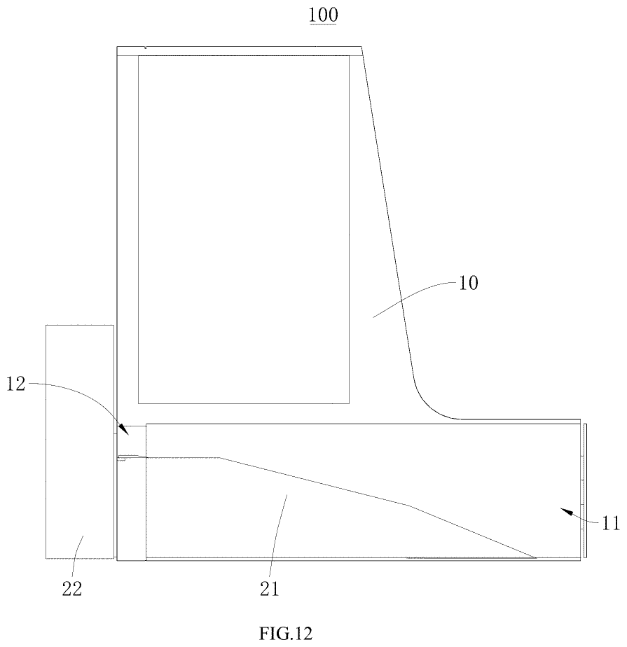

Referring to FIG. 11, FIG. 11 is a schematic side view of the structure of the cleaning base station 100 provided by this embodiment, and shows the internal structure of the base 10. The structure of this embodiment is a modification on the basis of FIG. 2. In this embodiment, the part 221 of the first sewage tank 22 extends out of the base 10. This structure can increase the volume of the first sewage tank 22 so as to store more sewage, which can reduce the cleaning times of the cleaning base station 100 and is convenient to use. In one embodiment, the part 221 of the first sewage tank 22 extending from the base 10 is located on the side corresponding to the opening 12 on the base 10 to facilitate the production and assembly of the first sewage tank 22 and the base 10.

In another embodiment, the part 221 of the first sewage tank 22 extending from base 10 extends to the opposite sides of base 10 and the side of base 10 away from entrance 11, so that the part of first sewage tank 22 protruding from base 10 surrounds the three sides of base 10 to increase the volume of the first sewage tank 22 and to reduce the cleaning times of the cleaning base station 100 and which is convenient to use.

Referring to FIG. 12, FIG. 12 is a schematic side view of the structure of the cleaning base station 100 provided by this embodiment, and shows the internal structure of the base 10. The structure of this embodiment is a modification on the basis of FIG. 11. In this embodiment, the first sewage tank 22 is arranged outside the base 10, so that the space occupied by the first sewage tank 22 in the base 10 can be reduced, the volume of the base 10 can be made smaller, and the volume of the first sewage tank 22 can be conveniently increased.

In one embodiment, the first sewage tank 22 is arranged on the side of the base 10 corresponding to the opening 12 to facilitate the production and assembly of the first sewage tank 22 with the base 10.

in another embodiment, the first sewage tank 22 extends to the opposite sides of the base 10 and the side of the base 10 away from the entrance 11, so that the first sewage tank 22 surrounds the three sides of the base 10 to increase the volume of the first sewage tank 22 and reduce the cleaning frequency of station100, which is convenient to use.

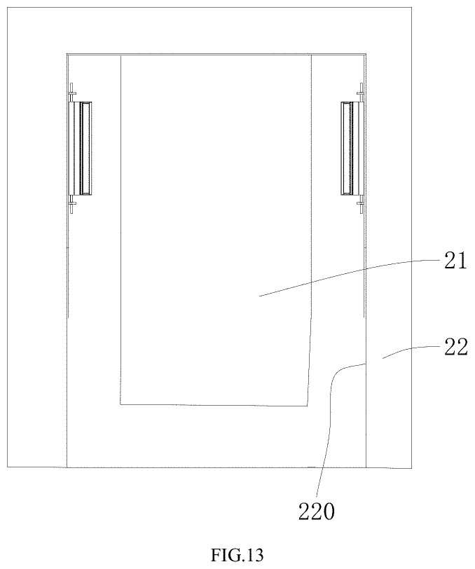

Referring to FIG. 13, which is a schematic top view of the cleaning tank 21 and the first sewage tank 22 in this embodiment. The structure of this embodiment is a modification on the basis of FIG. 11. In this embodiment, the first sewage tank 22 is arranged in a U-shape, the first sewage tank 22 is enclosed into U-shaped groove 220, and the cleaning tank 21 is arranged in the U-shaped groove 220, so that the height of the first sewage tank 22 and the cleaning tank 21 is small for storage, if it is possible to arrange it under the cabinet of the washing machine or under the washstand in the bathroom to save space.

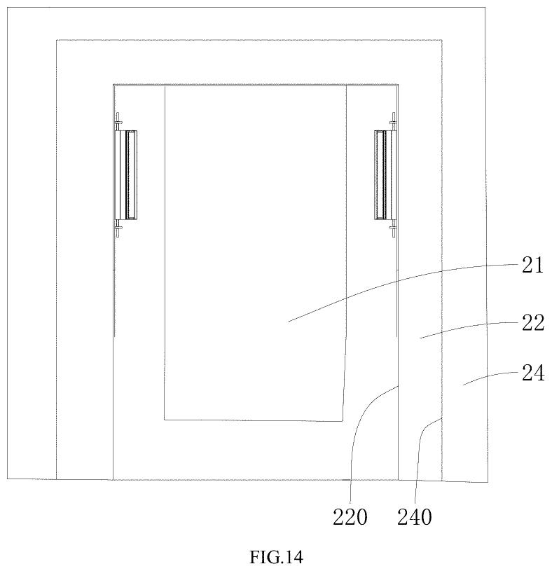

Referring to FIG. 14, FIG. 14 is a schematic top view of the cleaning tank 21, the first sewage tank 22 and the water purification tank of this embodiment. The structure of this embodiment is a modification on the basis of FIG. 13. In this embodiment, the cleaning base station 100 further includes a water purification tank 24, and the water purification tank 24 is arranged to provide purified water to the cleaning tank 21 when cleaning is required. The first sewage tank 22 is arranged in a U shape, the first sewage tank 22 is enclosed into a U-shaped groove 220, the water purification tank 24 is arranged in a U shape, the water purification tank 24 is enclosed in a U-shaped cavity 240; the first sewage tank 22 is arranged in the U-shaped cavity 240, and the cleaning tank 21 is arranged in U-shaped groove220, in order to reduce the height, which is convenient to store and save storage space.

In other embodiments, the water purification tank 24 can also be arranged in the U-shaped groove 220, and the cleaning tank 21 can be arranged in the U-shaped cavity 240, that is, the inside is the cleaning tank 21, the middle is the water purification tank 24, and the outside is the first sewage tank 22. The height can also be lowered to facilitate storage and save storage space.

In other embodiments, when the water purification tank 24 is not arranged, the clean water can be directly supplied to the cleaning tank 21 through the faucet.

The cleaning base 10 of the embodiment of the present application can facilitate cleaning of the wiper of the cleaning robot 90, and can take out the cleaning tank 21 and the sewage tank together for cleaning, which is convenient to use.

The above are only optional embodiments of the present application and are not intended to limit the present application. Any modification, equivalent replacement and improvement made within the spirit and principle of the present application shall be within the protection of the present application.

What is claimed is:

1. A cleaning base station, comprising:
a base,
a cleaning tank configured for cleaning wipers, and
a first sewage tank configured for storing sewage;
wherein the cleaning tank is arranged in the base, an entrance is arranged on the base for a cleaning robot to enter the cleaning tank, a side of the base is defined with an opening configured for allowing the cleaning tank to be taken out, and the first sewage tank is connected to the cleaning tank.

2. The cleaning base station of claim 1, wherein the cleaning tank is detachably connected to the first sewage tank.

3. The cleaning base station of claim 1, wherein the first sewage tank is arranged beneath the cleaning tank.

4. The cleaning base station of claim 3, wherein a bottom of the cleaning tank is provided with an accommodation cavity, and the first sewage tank is arranged in the accommodation cavity.

5. The cleaning base station of claim 4, wherein a side of the accommodating cavity away from the entrance and/or a side of the accommodating cavity close to the entrance are open, and the first sewage tank is inserted into the accommodating cavity.

6. The cleaning base station of claim 4, wherein a bottom of the accommodating cavity is open, and a side wall of the accommodating cavity is arranged around the first sewage tank.

7. The cleaning base station of claim 1, further comprising an integrated box with an open top, wherein a supporting plate for supporting the cleaning robot is arranged in the integrated box, a part of the integrated box beneath the supporting plate constitutes the first sewage tank, and a part of the integrated box above the supporting plate constitutes the cleaning tank.

8. The cleaning base station of claim 7, wherein a width of the supporting plate is smaller than a width of the integrated box; or the integrated box is separated by the supporting plate, and the supporting plate defines a through hole.

9. The cleaning base station of claim 1, wherein the first sewage tank at least partially extends out of the base.

10. The cleaning base station of claim 9, wherein a part of the first sewage tank extending from the base extends to opposite sides of the base and a side of the base away from the entrance.

11. The cleaning base station of claim 1, wherein the first sewage tank is arranged in a U-shape, the first sewage tank is enclosed into a U-shaped groove, and the cleaning tank is arranged in the U-shaped groove.

12. The cleaning base station of claim 1, wherein the first sewage tank is arranged in a U-shape, the first sewage tank is enclosed into a U-shaped groove. The cleaning base station further comprising a water purification tank, wherein the water purification tank is arranged in a U-shaped, and the water purification tank is enclosed into a U-shaped cavity; and
the first sewage tank is arranged in the U-shaped cavity, and the cleaning tank is arranged in the U-shaped groove; or, the water purification tank is arranged in the U-shaped groove, and the cleaning tank is arranged in the U-shaped cavity.

13. The cleaning base station of claim 1, further comprising a second sewage tank, wherein the second sewage tank is arranged on the outside of the base, and the second sewage tank is connected to the cleaning tank.

14. The cleaning base station of claim 1, wherein the opening is defined on a side of the base away from the entrance and/or a side of the base close to the entrance.

15. The cleaning base station of claim 1, wherein the cleaning tank is inclined downward on a side close to the entrance.
